(19) United States
(12) Patent Application Publication
(10) Pub. No.: US 2008/0293479 A1
(43) Pub. Date: Nov. 27, 2008

(54) Method for the selective display, review, pricing, recommendation and acceptance of free goods and services requiring varying scales of play at a casino via the World Wide Web

(75) Inventors: George Nassef,, New York, NY (US); Kelly Michaelian, New York, NY (US); Jeffrey Yang, New York, NY (US)

Correspondence Address: FURR LAW FIRM, 2622 DEBOLT ROAD, UTICA, OH, 43080, US

(73) Assignee: VALETNOIR, INC., New York, NY (US)

(21) Appl. No.: 11/751,151

(22) Filed: May 21, 2007

(51) Int. Cl. A63F 13/00

(52) U.S. Cl. 463/25

(57) ABSTRACT

This invention relates to the art of facilitating the ability for the selective display, review, pricing, recommendation and acceptance (“shopping”) of free goods and services requiring varying scales of play at a casino (“comps”) more particularly using the World Wide Web (“Internet”) to do it. The invention will support numerous languages.

### BACKGROUND

This invention relates to the selective display, review, pricing, recommendation and acceptance (“shopping”) of free goods and services requiring varying scales of play at a casino (“comps”) more particularly using the World Wide Web (“Internet”) to do it.

### DESCRIPTION OF PRIOR ART

There exist many forms of making reservations and many reservations systems designed to be operated by humans at a casino for the purpose of bringing an established player to the property for services. For the purposes of discussion, an established player is a customer of a casino property that has historical play with a casino stored in the casino's Customer Management System or another similar filing system which identifies the games played, hours played, amounts wagered and other information common in the industry which would be used to identify the player and qualify the player for acceptance (“shopping”) of free goods and services requiring varying scales of play at a casino (“comps”). These established players are preferred in some instances to players who are not established, or “rated.”

Historically, systems used by casinos to market to established players are self-contained and designed by programmers to be operated by casino personnel. These systems have no ability to be used by the established casino patrons themselves for the purposes of planning services. Some systems have been extended to permit limited self-service on the gaming floor by an established player for the purpose of obtaining free or discounted services like meals while on-property; however, these systems require that the established player already be a member of that particular casino's frequent player program (i.e. they must be rated at that casino). These systems work quite well for established patrons returning for additional services, future trips, or free meals.

While these systems take into account a returning player that has previously been rated in their casino system, none seem to handle the established player with past play at a competitor's casino property, who is new to this particular casino property and/or brand. Further, despite much automation in the decision-making ability of the existing player development service systems, which are designed to approve discounted and free services for returning players, the highest of services to established players of competitive properties must still be approved manually with human intervention. Often this approval process is handled by a special customer service agent called a “host” or by a member of the senior marketing staff. It is routine in the host's industry to make phone calls, obtain faxes, and use human networking techniques to validate the past play of an established player at a different property. Existing systems stop short of any automated or mechanical means to validate the past play of an established player who has not yet visited a casino's property or sister properties.

Therefore a continuing need exists for a system that will selectiving display, review, price, recommend and accept (“shopping”) of free goods and services requiring varying scales of play at a casino (“comps”).

### SUMMARY

An object of the present invention comprises a method and apparatus for facilitating the selective display, review, pricing, recommendation and acceptance (“shopping”) of free goods and services requiring varying scales of play at a casino (“comps”) more particularly using the World Wide Web (“Internet”) to do it. The invention will support numerous languages. Furthermore, since the system is designed with multiple languages, the casino patron may self-service in their native language while the system validates their play, forms an audit trail and interacts with staff members at casino destinations independent of the patron's native language. The present implementation supports seven languages including French, English, German, Spanish, Italian, Chinese, and Portuguese; however, the embodiment of this invention is by no means limited by these seven languages.

A further object of the present invention is to provide all interested parties of the transaction with the current status of the established player's past play lookup, the status of the reservation or request for amenities or services from the prospective casinos, and a list or combination of services, discounts or free amenities that the player qualifies for on the planned trip based upon an application of the house rules for the chosen casino. These house rules are programmatically entered by the operating casino staff members and are capable of determining eligibility around the clock to self-servicing casino patrons electronically.

The current invention can utilize the Internet. The Internet comprises a vast number of computers and computer networks that are interconnected through communication links. The interconnected computers exchange information using various services, such as electronic mail, Gopher, and the World Wide Web (“WWW”). The WWW service allows a server computer system (i.e., Web server or Web site) to send graphical Web pages of information to a remote client computer system. The remote client computer system can then display the Web pages. Each resource (e.g., computer or Web page) of the WWW is uniquely identifiable by a Uniform Resource Locator (“URL”). To view a specific Web page, a client computer system specifies the URL for that Web page in a request (e.g., a Hypertext Transfer Protocol (“HTTP”) request). The request is forwarded to the Web server that supports that Web page. When that Web server receives the request, it sends that Web page to the client computer system. When the client computer system receives that Web page, it typically displays the Web page using a browser. A browser is a special-purpose application program that affects the requesting of Web pages and the displaying of Web pages.

The system is more efficient, effective, accurate and functional than the current art.

### BRIEF DESCRIPTION OF DRAWINGS

Without restricting the full scope of this invention, the preferred form of this invention is illustrated in the following drawings:

FIG. 1 shows an overview of how a casino player accesses the system through the Internet;

FIG. 2 shows a sample of casino players' computers connecting to the system;

FIG. 3 shows the system notifying a player;

FIG. 4 shows the offers across a number of casino available to a client;

FIG. 5 shows a screen shot of what a Player can receive;

FIG. 6 displays a screenshot showing the breakdowns; and

FIG. 7 displays the system contacting other systems.

### DETAILED DESCRIPTION

The following description is demonstrative in nature and is not intended to limit the scope of the invention or its application of uses.

There are a number of significant design features and improvements incorporated within the invention.

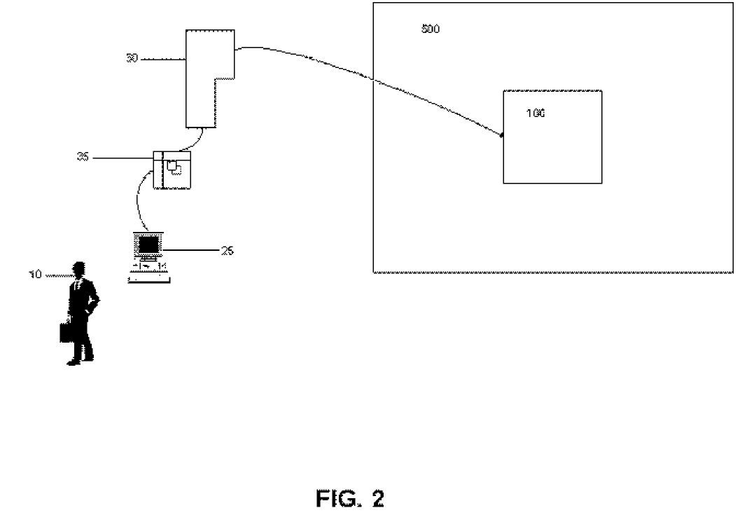

As shown in FIG. 2, the present invention comprises a computer 25 with the software 35 program recorded on a computer-readable medium 30, for controlling the computer of a potential client to maintain and generate for the selective display, review, pricing, recommendation and acceptance (“shopping”) of free goods and services requiring varying scales of play at a casino (“comps”). The software program interacts with the database of information and creates lists of approved comps, and other data that can be accessed via the Internet. Specifically, the software program is adapted to be run by a potential client's computer to control the computer to generate a computer readable file (requested services file) that includes information pertaining to trips, contacts, age, gender, etc that can be accessed from a remote site via the Internet 500. For example, these files can be posted as a Web site 100 on the World Wide Web 500.

The present invention comprises a method and apparatus for providing a potential client 120, such as a casino player, self-service functionality with time and destination components that dramatically extend the art of established rated casino player self-servicing for players 120 serviced within a business that are planning to travel to a casino establishment. Additionally, the potential client 120 operates in their own spoken and written dialect or language. More specifically, the present invention relates to a method and apparatus which enables these potential clients to record all aspects of their past-play and the systems automatically validate the past play at the casinos where the player was previously established as a player 120 during the lookup process by maintaining a database 310 of historical, phase and state information pertaining to the transaction used in the business to introduce players 120 to the new property for an upcoming trip. The current invention accomplishes this via a global computer information network, such as the Internet 500, to record data relevant to the transaction while enforcing a series of business rules which must be followed during the transaction as defined by the casino's business operation. These rules must be followed to satisfy certain legal, regulatory or common-sense guidelines during the booking process and are inherent in the system.

The present invention further enables casino personnel to use the Internet 500 to manage and approve the transactions, perform reporting, create graphical representations of the process, value the transactions, the destinations and relative business being formed at each of the destinations or offices, verify staff and internal personnel performance, create graphs and other reports both online and offline on the relative performance of customer service personnel performing the functions on the part of the self-service system.

The computer application that includes the user interface for this invention will henceforth be referred to as the “System 1.” The system is network-based and works on an Internet, Intranet and/or Wireless network basis as well as a stand-alone and fax-based system.

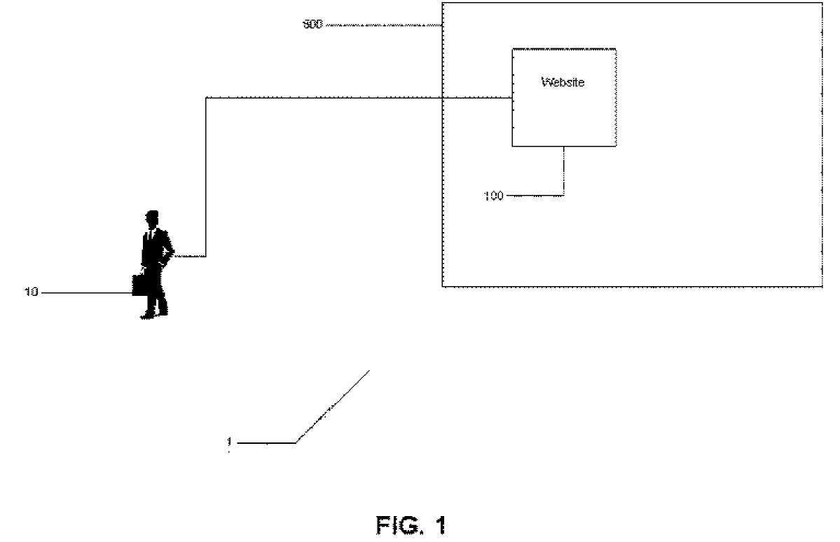

FIG. 1 illustrates a functional diagram of a computer network for World Wide Web 500 access to the System 1 from a plurality of Users 10 who accesses the system Web Site 100 or the Users 10 can connect directly to the System 1. Accessing the System Web Site 100 can be accomplished directly through a communication means such as a direct connection, an intranet, a local Internet Service Provider, often referred to as ISPs, or through an on-line service provider like CompuServe, Prodigy, or American Online, etc. or Wireless devices using services like AT&T or Verizon.

The Users 10 contact the System Web Site 100 using an informational processing system (Client) capable of running an HTML compliant Web browser such as Microsoft's Internet Explorer, Netscape Navigator, Lynx or Mosaic. A typical system that is used is a personal computer with an operating system such as Windows 95, 98 or ME, NT, 2000 or Linux running a Web browser. The exact hardware configuration of computer used by the Users 10, the brand of operating system or the brand of Web browser configuration is unimportant to understand this present invention. Those skilled in the art can conclude that any HTML (Hyper Text Markup Language) compatible Web browser is within the true spirit of this invention and the scope of the claims.

In one preferred embodiment of the invention, the Users 10 and/or Casinos 20 connect to the System Web Site 100. In the preferred embodiment the system has numerous web pages. The information in the web pages are in HTML format via the Hypertext Transport Protocol (http) and on Server System database 310. The User System 110 includes software to allow viewing of web pages in multiple languages including double-byte implementations, commonly referred to as a Web Browser, such as Communicator available from Netscape Communications Corp. or Internet Explorer available from Microsoft Corp. The user system is capable of accessing web pages located on Server System database 310.

Output can include a graphical user interface, hardcopy, facsimile, e-mail, messaging or other communication with any humanly or machine discernable data and/or artifacts. In some embodiments, output can include transmitting the risk variable related data to a designated recipient, any humanly or machine discernable data and/or artifacts.

The system 1 is set to run on a computing device. A computing device on which the present invention can run would be comprised of a CPU, Hard Disk Drive, Keyboard, Monitor, CPU Main Memory and a portion of main memory where the system resides and executes. A printer can also be included. Any general-purpose computer with an appropriate amount of storage space is suitable for this purpose. Computer Devices like this are well known in the art and are not pertinent to the invention. The computing device can serve as a server.

The invention comprises a method and apparatus for providing a game of chance player self-service system for players 120 serviced within a business that are being provided to a casino establishment without the need for a host to approve amenities which would normally only be approved for an established returning customer by accessing historical play information from competing casino locations via a wide area network. The system 1 will selectively display, review, price, recommendation and accept (“shopping”) free goods and services offered based on varying scales of play at a casino (“comps”).

The system 1 enables casino staff/users 10 to record data relevant to the transaction of delivery of casino clients 120 to destinations, casinos, venues, bars, nightclubs, and to each other including, but not limited to: the stage of the introduction process, preferred language, desired dates of travel, desired casino play, past play, past casino trips, desired travel, qualifying information, personal data, pictures, methods of transportation, personal greeting and meeting information, alerts, probability of travel coming to fruition, charges related to the trip, credit and front-money requirements for the trip, arrival and departure dates, nightclub and other entertainment information, personal travel companions, spouse information, group leaders and other attributes associated with the other individuals on the trip. The system 1 will maintain and generate selective display, review, pricing, recommendation and acceptance (“shopping”) of free goods and services requiring varying scales of play at a casino (“comps”).

These items are stored on the system's database 310. The system 1 enforces business rules and logic required by the site's business against these data to ensure that a business process is followed that maximizes profit, play and travel.

Casino Clients or Hosts as Users 10 can search this collection of data from the database using a series of qualifying criteria or context criteria, including dates of travel, age of member, gender of member, spouse or travel partner, desired games to be played, historical games played, complimentary status, approved or rejected complementarities, approved or rejected service amenities (meals, limos, etc), previous trips, “do not call” lists, common interests, play history, body features, pictures, and facial recognition attributes for security processing against criminal data as well as other personal information which may be of interest to a venue or person traveling.

The system 1 further enables a client 120 to be searched from a multiplicity of such clients, based upon their attributes, play or travel history. The method and apparatus further enables a client 120 to be searched based upon their desired destination. The method and apparatus further enables a player 120 to be searched based on their preferred games or style of playing games of chance. Standard search methodology that is commonly known in the art is used.

The system 1 enables the site administrator, client 120 or venue service personnel, as a User 10, to verify the client's profile information in real-time, batch or via the Internet with remote computer systems operated by the casino service provider for the purposes of scoring the client's profile against actual data collected during a previous visit of the player 120 to the casino service provider. The system 1 as a web-based system permits any licensed user 10 to book clients 120 via the web directly into a casino's or hotel's system.

The system 1 will enable the administrator, client or venue service personnel, as a User 10, to use this score against a series of criteria (rules) that match the casino service providers desired customers for a specific future travel date specified by the representative, player or casino service personnel, and to transmit this data back through the system for established players traveling to new casinos other than this one.

Thus, the venue service personnel may take hypothetical pairings of potential casino patrons and extrapolate the potential value of these patrons and pre-emptively make such an offer to entice them to return. This allows the venue, client or casino service personnel to concentrate on those players 120 that match specific criteria and maximize venue use or profit.

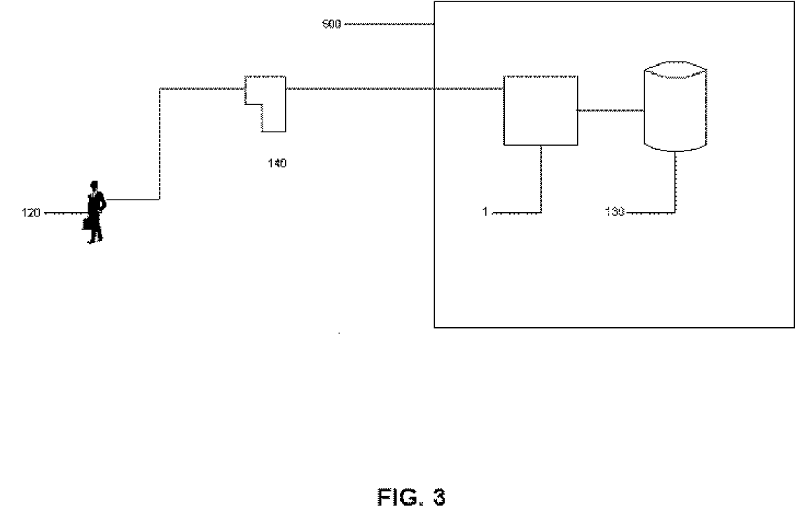

The system 1 is connected to other databases and computer systems, such as hotel reservation systems 130, allowing it the capability of monitoring gaming service provider hotel inventories, gaming space, and desired gamers and notifying the player 120 when a casino service provider has comps for which the player is qualified and/or interested. The system 1 can notify the player 120 and/or the service provider 20 through E-mail, mail, phone, fax or any other means of communications 140 as shown in FIG. 3.

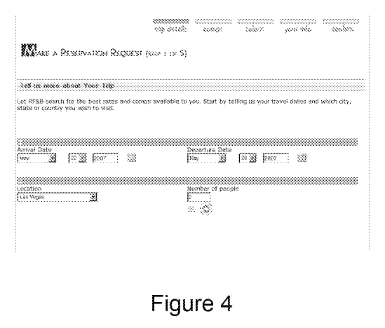

As shown in FIG. 4, a player 120 can enter a date or range of dates and see all free casino offers across multiple types of properties, cruises, and brands—or—“shop” for comps based on their own unique play history, characteristics or actuals as stored in the system 1.

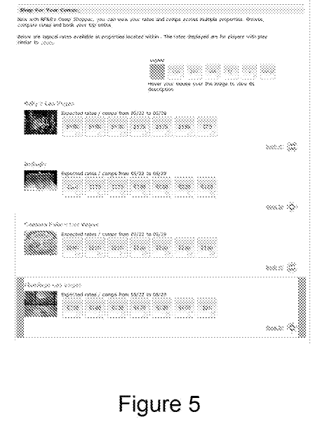

FIG. 5 shows that the Player 120 can see pictures and the “relative” cost of each room (if it isn't free) along with services that would be free if the player agrees to stay at the property and “play”.

As described in the related “Method Apparatus and System for permitting the self-service of established casino players to new casino destinations in the Gaming Industry via a Wide Area Network” patent application Ser. No. 10/711,106 and incorporated by reference, a player 120 can then book the stay online using his/her qualifications which went into the shopping experience.

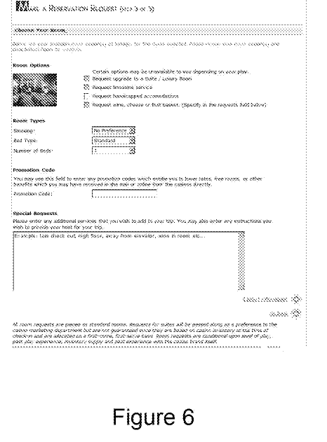

As shown in FIG. 6, the system 1 takes all the various criteria from the properties which the system 1 contracts with and breaks them down by date, play level, comp status, room type, number of beds and equates these values to an abstract rating in order to load them into a 3-D Matrix of values which the system can reference and cross disparate property nomenclature in order to display accurate comp and price results. If the player 120 doesn't qualify for comps at other properties, the closest casino rate is displayed. If casino rates don't apply, the system 1 looks up the prevailing discount or rack rate available to non-players in real-time in connection to a travel agent GDS system such as Worldspan and uses real-time rate and inventory information in place of an online comp inventory.

The system 1 also has administration panels where the users 10 can change inventory levels by property, date, and play level required for a particular comp, casino rate, service or discount.

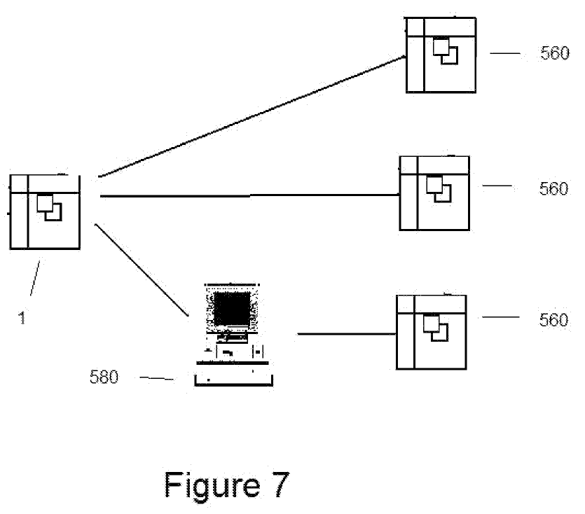

As shown in FIG. 7, the system 1 also ties into the casino's systems 560 to make the comp reservation online-even though their systems were heretofore completely human-interface, the system 1 has keystroke emulators 580 to bypass the human and submit the comp reservation electronically.

The system 1, when used by brokers or casino representatives, also has features which permit the broker to “list” the player 120 into multiple properties simultaneously as “walk-ins” which greatly increases the amount of casino commission which can be achieved by the representative since the rep does not have to predict the exact behavior of the player when they arrive in the casino town. This feature is an “auto-walkin” booking.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A system for gaming players comprising: having the selective display, review, pricing, recommendation and acceptance of goods and services offered by a gaming location.

2. A system for gaming players of claim 1 further comprising requiring varying scales of play at a gaming location for said goods and services.

3. A system for gaming players of claim 1 further comprising where said goods and services are offered free.

4. A system for gaming players of claim 1 further comprising; Having a database; Having said database contain data about a player; Having said database contain gaming history about the gaming player.

5. A system for gaming players of claim 1 further comprising having said system being accessible by a user through the Internet.

6. A system for gaming players of claim 1 further comprising having said data being historic data of said gaming player from other properties.

7. A system for gaming players of claim 3 further comprising having said historic data being the gaming history of said casino client.

8. A system for gaming players of claim 1 further comprising having said data being the actuals, wagering data, win/loss, property, player account number, credit line information, service dates, and preference data of said client.

9. A system for gaming players claim 1 further comprising having said system connecting to other database systems owned by a plurality of companies.

10. A system for gaming players claim 1 further comprising; allowing said data to be accessed by users of the system.

11. A system for gaming players claim 1 further comprising where said system supports a plurality of languages.

12. A system for gaming players claim 1 further comprising where said system has a communication means for players and users to contact each other in their native languages, not necessarily the same language on both ends of the conversation.

13. A system for gaming players comprising: having the selective display, review, pricing, recommendation and acceptance of goods and services offered by a gaming location, requiring varying scales of play at a gaming location for said goods and services where said goods and services are offered free and having said system being accessible by a user through the Internet.

14. A system for gaming players of claim 13 further comprising; Having a database; Having said database contain data about a player; Having said database contain gaming history about the gaming player.

15. A system for gaming players of claim 13 further comprising having said data being historic data of said gaming player from other properties.

16. A system for gaming players of claim 15 further comprising having said historic data being the gaming history of said casino client.

17. A system for gaming players of claim 13 further comprising having said data being the actuals, wagering data, win/loss, property, player account number, credit line information, service dates, and preference data of said client.

18. A system for gaming players claim 13 further comprising having said system connecting to other database systems owned by a plurality of companies.

19. A system for gaming players claim 13 further comprising; allowing said data to be accessed by users of the system.

20. A system for gaming players claim 13 further comprising where said system supports a plurality of languages.
